(19) United States
(12) Patent Application Publication
(10) Pub. No.: US 2026/0186331 A1
(43) Pub. Date: Jul. 2, 2026

(54) OPTICAL ELEMENT, LIGHT GUIDE ELEMENT, AND AR DISPLAY DEVICE

(71) Applicant: Sharp Display Technology Corporation, Kameyama City (JP)

(72) Inventors: Ryosuke SAIGUSA, Kameyama City (JP); Akira SAKAI, Kameyama City (JP); Yuichi KAWAHIRA, Kameyama City (JP); Takeshi OYAMA, Kameyama City (JP)

(21) Appl. No.: 19/430,774

(22) Filed: Dec. 23, 2025

(30) Foreign Application Priority Data
Dec. 27, 2024 (JP) 2024-232016

(51) Int. Cl. G02F 1/13; C09K 19/36; C09K 19/58; G02B 27/01; G02F 1/1333

(52) U.S. Cl. CPC G02F 1/1313; C09K 19/36; C09K 19/586; G02B 27/0172; G02F 1/1326; G02F 1/133365; C09K 2219/03

(57) ABSTRACT

An optical element is provided that includes: a cholesteric liquid crystal layer including a stack of a first cholesteric liquid crystal layer and a second cholesteric liquid crystal layer. The first and second cholesteric liquid crystal layers each contain a polymer of a polymerizable liquid crystal compound and a chiral agent. The first cholesteric liquid crystal layer has a shorter helical pitch in the first region than in the second region and the second cholesteric liquid crystal layer having a longer helical pitch in the first region than in the second region. The first region is closer to a first end portion than to a central portion in an in-plane first direction, and the second region is closer to a second end portion than to the central portion in the first direction.

### CROSS-REFERENCE TO RELATED APPLICATIONS

The present application claims priority under 35 U.S.C. § 119 to Japanese Patent Application No. 2024-232016 filed on Dec. 27, 2024, the contents of which are incorporated herein by reference in their entirety.

### BACKGROUND

### Technical Field

The following disclosure relates to optical elements, light guide elements, and AR display devices.

### Description of Related Art

There has been active research and development of augmented reality (AR) display devices that overlay images onto the real-world view. For example, AR glasses have been proposed that overlay video content from a display device onto the user's view of the real world by directing display light into one end of a light guide plate and allowing the light to propagate and exit from the other end. Some of these AR glasses incorporate a diffraction element that utilizes a liquid crystal layer containing a chiral agent. Specifically, it has been known to utilize a cholesteric liquid crystal layer having a liquid crystal alignment pattern in which the optical axis derived from the liquid crystal compound continuously rotates along at least one in-plane direction (for example, US 2021/0397008 A1, WO 2019/189852, WO 2020/122119).

### SUMMARY

(1) One embodiment of the present invention is directed to an optical element, including: a cholesteric liquid crystal layer including a first cholesteric liquid crystal layer and a second cholesteric liquid crystal layer stacked on the first cholesteric liquid crystal layer, the first cholesteric liquid crystal layer and the second cholesteric liquid crystal layer each containing a polymer of a polymerizable liquid crystal compound and a chiral agent, the cholesteric liquid crystal layer including a first region which is closer to a first end portion than to a central portion in a first direction within a plane, and a second region which is closer to a second end portion than to the central portion in the first direction, the cholesteric liquid crystal layer satisfying one of the following conditions: the first cholesteric liquid crystal layer having a shorter helical pitch in the first region than in the second region and the second cholesteric liquid crystal layer having a longer helical pitch in the first region than in the second region; or the first cholesteric liquid crystal layer having a longer helical pitch in the first region than in the second region and the second cholesteric liquid crystal layer having a shorter helical pitch in the first region than in the second region.
(2) In an embodiment of the present invention, the optical element includes the structure (1), and in a region between the first region and the second region of the cholesteric liquid crystal layer, the helical pitch in the first cholesteric liquid crystal layer gradually increases in a direction from the first region toward the second region and the helical pitch in the second cholesteric liquid crystal layer gradually decreases in the direction from the first region toward the second region, or the helical pitch in the first cholesteric liquid crystal layer gradually decreases in the direction from the first region toward the second region and the helical pitch in the second cholesteric liquid crystal layer gradually increases in the direction from the first region toward the second region.
(3) In an embodiment of the present invention, the optical element includes the structure (1) or (2), and in the cholesteric liquid crystal layer, a difference between two reflectance peak wavelengths which is the difference between a reflectance peak wavelength in the first cholesteric liquid crystal layer and a reflectance peak wavelength in the second cholesteric liquid crystal layer is smaller in the second region than in the first region.
(4) In an embodiment of the present invention, the optical element includes the structure (3), and in a region between the first region and the second region of the cholesteric liquid crystal layer, the difference between two reflectance peak wavelengths gradually decreases in the direction from the first region toward the second region.
(5) In an embodiment of the present invention, the optical element includes the structure (1), (2), (3) or (4), and in the cholesteric liquid crystal layer, reflectance in the first region exhibits a peak within a wavelength range of 450 nm or shorter and a peak within a wavelength range of 650 nm or longer, and reflectance in the second region exhibits two peaks within a wavelength range of 450 nm or longer and 650 nm or shorter.
(6) In an embodiment of the present invention, the optical element includes the structure (1), (2), (3), (4) or (5), the first region includes the first end portion of the cholesteric liquid crystal layer, and the second region includes the second end portion of the cholesteric liquid crystal layer.
(7) Another embodiment of the present invention is directed to a light guide element including: a light guide plate; a light incident-side optical element mounted on a light incident side of the light guide plate; and a light emission-side optical element which is the optical element including any one of the structures (1) to (6) and is mounted on a light emission side of the light guide plate, the first end portion of the cholesteric liquid crystal layer is an end portion closest to a light incident-side end portion of the light guide plate, and the second end portion of the cholesteric liquid crystal layer is an end portion farthest from the light incident-side end portion of the light guide plate.
(8) Yet another embodiment of the present invention is directed to an AR display device, including: the light guide element including the structure (7); and a display module facing the light incident-side optical element. The present disclosure can provide an optical element that uses a cholesteric liquid crystal and has a wide range of reflective wavelengths and high productivity, and a light guide element and an AR display device each including the optical element.

### BRIEF DESCRIPTION OF THE DRAWINGS

FIG. 1 is a schematic cross-sectional view of an optical element according to Embodiment 1.

FIG. 2 is an enlarged cross-sectional view of a first region A in FIG. 1.

FIG. 3 is a graph showing the reflection spectrum of a typical single-layer cholesteric liquid crystal layer.

FIG. 4 is a schematic cross-sectional view of a light guide element according to Embodiment 2.

FIG. 5 is an enlarged cross-sectional view of a first region A in FIG. 4.

FIG. 6 is a graph schematically showing the reflection spectra of cholesteric liquid crystal layers in the first region A in FIG. 4.

FIG. 7 is a graph schematically showing the reflection spectra of the cholesteric liquid crystal layers in a second region B in FIG. 4.

FIG. 8 is a diagram illustrating occurrence of luminance unevenness when the reflectance of a coupler is uniform within the plane.

FIG. 9 is a cross-sectional view used to illustrate the diffraction angles of an optical element according to Embodiment 2.

FIG. 10 is a cross-sectional view schematically showing the configuration of an optical element according to Embodiment 3 which includes a double-layer structure PVH.

FIG. 11 is a graph showing the reflection spectrum of a first PVH in FIG. 10.

FIG. 12 is a graph showing the reflection spectrum of a second PVH in FIG. 10.

FIG. 13 is a cross-sectional view schematically showing a triple-layer structure PVH.

FIG. 14 is a graph showing the reflection spectrum of a first PVH in FIG. 13.

FIG. 15 is a graph showing the reflection spectrum of a second PVH in FIG. 13.

FIG. 16 is a graph showing the reflection spectrum of a third PVH in FIG. 13.

FIG. 17 is a graph showing the reflectance of a cholesteric liquid crystal layer in Comparative Example 1.

FIG. 18 is a graph showing the reflectance of a cholesteric liquid crystal layer in Comparative Example 2.

FIG. 19 is a graph showing the reflectance of cholesteric liquid crystal layers in Example 1 and Comparative Example 2.

FIG. 20 is a flow diagram illustrating the mechanism by which the reflection wavelength of a cholesteric liquid crystal layer shifts when the cholesteric liquid crystal layer is obtained by coating a partially cured polymerizable liquid crystal compound with a polymerizable liquid crystal compound.

FIG. 21 is a graph showing the reflectance of a cholesteric liquid crystal layer in Example 2.

FIG. 22 is a schematic cross-sectional view of a light guide element for AR devices.

FIG. 23 is a schematic diagram of the light-guiding behavior of an outcoupler in a light guide element of Comparative Example 3.

FIG. 24 is a graph showing the relationship between the x-coordinate and the intensity of light emitted from a light guide plate in Comparative Example 3.

FIG. 25 is a graph showing the x-direction dependence of the reflectance of the outcouplers in Comparative Example 3 and Example 3.

FIG. 26 is a graph showing the calculation results of the relationship between the x-coordinate and the intensity of emitted light (in-plane luminance distribution) when the outcouplers in Comparative Example 3 and Example 3 are used.

### DETAILED DESCRIPTION

A cholesteric liquid crystal layer has a nature of selectively reflecting visible light. To improve the display quality of AR glasses, a diffraction element including a cholesteric liquid crystal layer capable of reflecting all red (R), green (G), and blue (B) components of visible light has been demanded. In principal, a stack of cholesteric liquid crystal layers selectively reflecting light components with different wavelengths can reflect RGB light components. However, such a stack of cholesteric liquid crystal layers has a productivity issue. Specifically, when a polymerizable liquid crystal compound is applied to a cholesteric liquid crystal layer obtained by curing a polymerizable liquid crystal compound, the applied polymerizable liquid crystal compound may be repelled by the surface of the cholesteric liquid crystal layer as the underlayer, or may exhibit misalignment due to insufficient alignment control.

In response to the above issues, the present disclosure aims to provide an optical element that uses a cholesteric liquid crystal and has a wide range of reflective wavelengths and high productivity, and a light guide element and an AR display device each including the optical element.

Hereinafter, embodiments of the present invention are described with reference to the drawings. The present invention is not limited to the following embodiments. The configurations of the embodiments may be combined or modified as appropriate without departing from the gist of the present invention.

In the following description, identical or functionally similar components are denoted by the same reference signs across different figures, and repeated descriptions thereof are omitted as appropriate.

Herein, “Re (λ)” represents the in-plane phase difference introduced to light with a wavelength λ (unit: nm).

### Embodiment 1

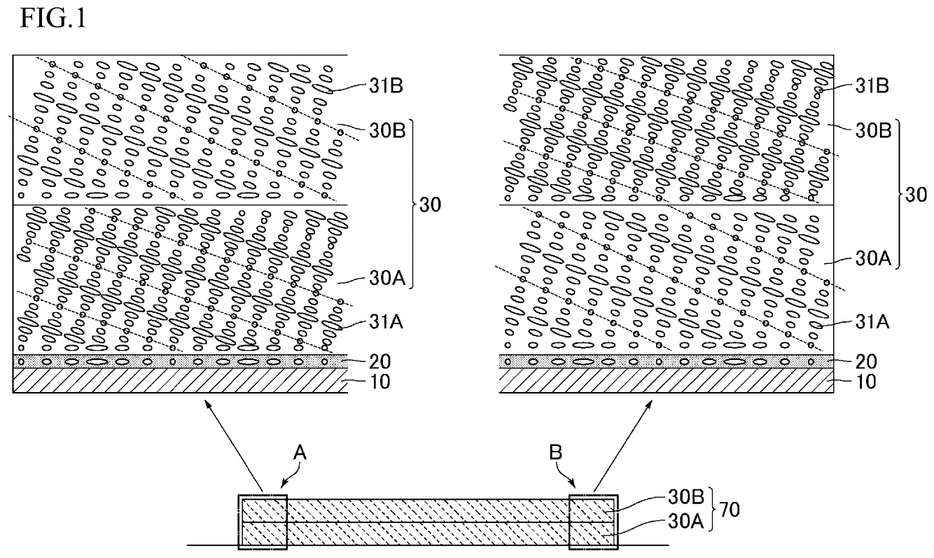

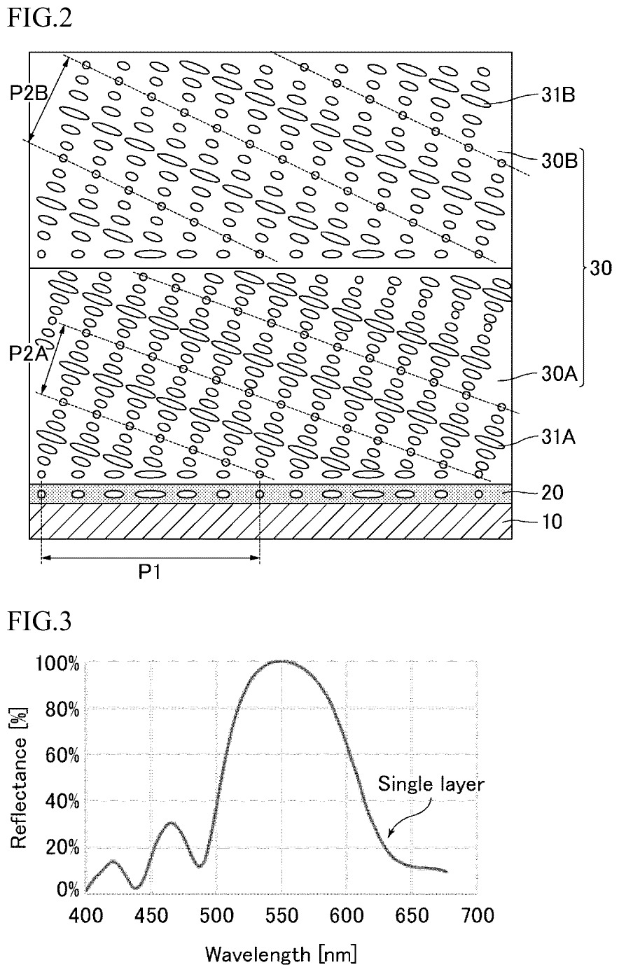

FIG. 1 is a schematic cross-sectional view of an optical element according to Embodiment 1, showing the entire optical element, an enlarged cross section of a first region A, and an enlarged cross section of a second region B. FIG. 2 is an enlarged cross-sectional view of the first region A in FIG. 1. As shown in the figures, an optical element 70 according to Embodiment 1 has a configuration in which an alignment film 20 and a cholesteric liquid crystal layer 30 are stacked on a support 10. The cholesteric liquid crystal layer 30 includes a first cholesteric liquid crystal layer 30A, and a second cholesteric liquid crystal layer 30B stacked on the first cholesteric liquid crystal layer 30A.

### Support

The support 10 may be any member that supports the alignment film 20, the first cholesteric liquid crystal layer 30A, and the second cholesteric liquid crystal layer 30B. Examples include glass substrates and resin substrates. When the optical element 70 in the present embodiment is applied to a light guide element, the support 10 is preferably a light guide plate.

### Alignment Film

The alignment film 20 has a patterned in-plane alignment regulating force. Specifically, the alignment film 20 exerts an alignment regulating force that induces a pattern in which the slow axes of the molecules of a polymerizable liquid crystal compound 31A in the first cholesteric liquid crystal layer 30A rotate periodically within the plane. The pattern period (in-plane pattern period) P1 is adjusted, for example, to fall within the range of 200 to 600 nm.

The material of the alignment film 20 can be a polymer with a polyimide structure in the main chain, a polymer with a polyamic acid structure in the main chain, a polymer with a polysiloxane structure in the main chain, or any other material that is common in the field of liquid crystal panels. The alignment film 20 can be formed by coating the support 10 with an alignment film material. The coating method is not limited and may be, for example, flexographic printing, inkjet coating, or another method.

The alignment film 20 may be of any type, and may be a rubbing alignment film having been subjected to rubbing as an alignment treatment, or a photoalignment film having a photo-functional group and having been subjected to photoalignment treatment as an alignment treatment. In terms of patterning of the in-plane alignment regulating force in a complicated pattern, the alignment film 20 is preferably a photoalignment film.

### Cholesteric Liquid Crystal Layer

The first cholesteric liquid crystal layer 30A and the second cholesteric liquid crystal layer 30B are obtained by polymerizing the polymerizable liquid crystal compounds 31A and 31B each containing a chiral agent, respectively. The chiral agent aligns the molecules of the polymerizable liquid crystal compounds 31A and 31B in directions continuously varying along the thickness directions of the first cholesteric liquid crystal layer 30A and the second cholesteric liquid crystal layer 30B, respectively, forming helical molecular alignments. The helical molecular alignments are stabilized by polymerization. Herein, the period corresponding to one full rotation in a helical molecular alignment is referred to as the “helical pitch” or “chiral period”. A helical pitch P2A refers to the length along the helical axis over which the molecular orientation of the polymerizable liquid crystal compound 31A rotates 180°. A helical pitch P2B refers to the length along the helical axis over which the molecular orientation of the polymerizable liquid crystal compound 31B rotates 180°. In the present embodiment, the first cholesteric liquid crystal layer 30A and the second cholesteric liquid crystal layer 30B have a region in which the helical pitches P2A and P2B of the polymerizable liquid crystal compounds 31A and 31B differ from each other in a plan view. In other words, in a plan view of a stack of the first cholesteric liquid crystal layer 30A and the second cholesteric liquid crystal layer 30B, the helical pitches P2A and P2B differ in at least one region. The helical pitches P2A and P2B are adjusted, for example, within the range of 220 to 900 nm.

The helical axis is preferably tilted relative to the normal to the surfaces of the first cholesteric liquid crystal layer 30A and the second cholesteric liquid crystal layer 30B. In other words, when the direction parallel to the surfaces of the first cholesteric liquid crystal layer 30A and the second cholesteric liquid crystal layer 30B is defined as 0 degrees and the direction normal to the surfaces is defined as 90 degrees, the orientation of the helical axis (helical axis tilt angle) is selectable as appropriate within the range of 0 to 90 degrees depending on the function of the optical element of the present embodiment. For example, when the optical element of the present embodiment is applied to a light guide element, the helical axis tilt angle is preferably 40 degrees or greater and less than 80 degrees.

FIG. 3 is a graph showing the reflection spectrum of a typical single-layer cholesteric liquid crystal layer. As shown in the figure, in many cases, a typical single-layer cholesteric liquid crystal layer exhibits only one distinct reflectance peak within the visible spectrum, and is often designed so that the reflectance peak appears around a wavelength of 550 nm, which corresponds to the center of the visible spectrum.

In the present embodiment, the cholesteric liquid crystal layer 30 includes the first region A which is closer to a first end portion than to the central portion in a first direction within the plane, and the second region B which is closer to a second end portion than to the central portion in the first direction, and one of the following conditions is satisfied: (1) the first cholesteric liquid crystal layer 30A has a shorter helical pitch P2A of the polymerizable liquid crystal compound 31A in the first region A than in the second region B and the second cholesteric liquid crystal layer 30B has a longer the helical pitch P2B of the polymerizable liquid crystal compound 31B in the first region A than in the second region B; or (2) the first cholesteric liquid crystal layer 30A has a longer helical pitch P2A of the polymerizable liquid crystal compound 31A in the first region A than in the second region B and the second cholesteric liquid crystal layer 30B has a shorter helical pitch P2B of the polymerizable liquid crystal compound 31B in the first region A than in the second region B.

Also, in a region between the first region A and the second region B of the cholesteric liquid crystal layer 30, one of the following conditions may be satisfied: (1) the helical pitch P2A in the first cholesteric liquid crystal layer 30A gradually increases in a direction from the first region A toward the second region B and the helical pitch P2B in the second cholesteric liquid crystal layer 30B gradually decrease in the direction from the first region A toward the second region B; or (2) the helical pitch P2A in the first cholesteric liquid crystal layer 30A gradually decreases in the direction from the first region A toward the second region B and the helical pitch P2B in the second cholesteric liquid crystal layer 30B gradually increases in the direction from the first region A toward the second region B. The expression here that a pitch “gradually increases (decreases)” encompasses both continuous and stepwise increase (decrease) in length.

With different helical pitches P2A and P2B, the reflectance peak wavelength in the first cholesteric liquid crystal layer 30A can be made different from the reflectance peak wavelength in the second cholesteric liquid crystal layer 30B. A shorter helical pitch leads to a shorter reflectance peak wavelength.

The term “reflectance peak” refers to a local maximum in reflectance of 40% or higher, based on normalization where the maximum reflectance within the wavelength range of 400 to 700 nm is set to 100%. The reflectance peak preferably refers to a local maximum in reflectance of 50% or higher, more preferably a local maximum in reflectance of 60% or higher, still more preferably a local maximum in reflectance of 70% or higher.

In the cholesteric liquid crystal layer 30, the difference between two reflectance peak wavelengths (the reflectance peak wavelength in the first cholesteric liquid crystal layer 30A and the reflectance peak wavelength in the second cholesteric liquid crystal layer 30B) may be smaller in the second region B than in the first region A. In the cholesteric liquid crystal layer 30, in the region between the first region A and the second region B, the difference between two reflectance peak wavelengths may gradually decrease in the direction from the first region A toward the second region B. The expression here that a difference “gradually decreases” encompasses both continuous and stepwise decrease. Varying the difference between two reflectance peak wavelengths within the plane enables in-plane distribution of RGB reflectance values. This can achieve a more uniform luminance distribution of reflected light from the optical element when the light source is arranged closer to the first end portion in the first direction. For example, in the cholesteric liquid crystal layer 30, the reflectance in the first region A may exhibit a peak within the wavelength range of 450 nm or shorter and a peak within the wavelength range of 650 nm or longer, and the reflectance in the second region B may exhibit two peaks within the wavelength range of 450 nm or longer and 650 nm or shorter.

The first region A may be any region closer to the first end portion than to the central portion in the first direction within the plane, and may be a region including the first end portion of the cholesteric liquid crystal layer 30. The second region B may be any region closer to the second end portion than to the central portion in the first direction, and may be a region including the second end portion of the cholesteric liquid crystal layer 30.

The reflection spectrum of the stack of the first cholesteric liquid crystal layer 30A and the second cholesteric liquid crystal layer 30B with different helical pitches P2A and P2B include a reflectance peak corresponding to the helical pitch P2A and a reflectance peak corresponding to the helical pitch P2B. The reflection spectrum therefore enables reflection over a broader range of wavelengths compared to a reflection spectrum that has only one reflectance peak. In terms of widening of the wavelength range, the cholesteric liquid crystal layer, which is the stack of the first cholesteric liquid crystal layer 30A and the second cholesteric liquid crystal layer 30B, preferably includes, within the plane, a stack region of a first reflective portion with a reflectance peak within the wavelength range of 400 to 550 nm (blue reflective portion which mainly reflects blue light) and a second reflective portion with a different reflectance peak from the first reflective portion within the wavelength range of 550 to 700 nm (red reflective portion which mainly reflects red light). When light including many components with wavelengths of 400 to 550 nm reflected by the first reflective portion is mixed with light including many components with wavelengths of 550 to 700 nm reflected by the second reflective portion, the reflectance of the cholesteric liquid crystal layer 30 as the stack of the first cholesteric liquid crystal layer 30A and the second cholesteric liquid crystal layer 30B can be made more uniform across the entire visible spectrum.

The reflectance peak in the first reflective portion preferably falls within the wavelength range of 400 to 500 nm, more preferably within the wavelength range of 420 to 480 nm. The reflectance peak in the second reflective portion preferably falls within the wavelength range of 600 to 700 nm, more preferably within the wavelength range of 620 to 680 nm. The difference between the reflectance peak in the first reflective portion and the reflectance peak in the second reflective portion is preferably 50 nm or more, more preferably 100 nm or more.

The helical pitch of the polymerizable liquid crystal compound in the first reflective portion is preferably 120 nm or more and 230 nm or less. The helical pitch of the polymerizable liquid crystal compound in the second reflective portion is preferably 170 nm or more and 290 nm or less.

In a conventional approach, the range of reflective wavelengths is widened by stacking cholesteric liquid crystal layers that selectively reflect light components with different wavelengths. However, this approach presents challenges, for example when a cholesteric liquid crystal layer obtained by curing a polymerizable liquid crystal compound is coated with a polymerizable liquid crystal compound, the applied polymerizable liquid crystal compound may be repelled by the surface of the underlying cholesteric liquid crystal layer or exhibit misalignment due to insufficient alignment control. In contrast, the present inventors found that the above problem can be solved by the method of coating a partially cured cholesteric liquid crystal layer with a polymerizable liquid crystal compound containing a chiral agent. This is presumably because when a cholesteric liquid crystal layer with a low degree of curing is coated with a polymerizable liquid crystal compound containing a chiral agent, uncured components of the polymerizable liquid crystal compound diffuse into the upper layer (the applied polymerizable liquid crystal compound) and the chiral agent diffuses toward the lower layer. This phenomenon can prevent repellence of the applied polymerizable liquid crystal compound 31B by the surface of the first cholesteric liquid crystal layer 30A, and can appropriately control the alignment of the polymerizable liquid crystal compound 31B. Also when the above method is used, the concentrations of the chiral agent in the first cholesteric liquid crystal layer 30A and the second cholesteric liquid crystal layer 30B can be easily made different. A higher concentration of the chiral agent leads to a shorter helical pitch (i.e., a shorter reflectance peak wavelength). Therefore, according to the above method, the helical pitches P2A and P2B of the polymerizable liquid crystal compounds 31A and 31B in the first cholesteric liquid crystal layer 30A and the second cholesteric liquid crystal layer 30B can be easily adjusted. The ultimate concentrations of the chiral agent in the first cholesteric liquid crystal layer 30A and the second cholesteric liquid crystal layer 30B are adjusted by both the concentration of the chiral agent in the applied polymerizable liquid crystal compound 31B and the degree of curing of the first cholesteric liquid crystal layer 30A when it is coated with the polymerizable liquid crystal compound 31B.

The polymerizable liquid crystal compounds 31A and 31B may be of any types, and conventionally known polymerizable liquid crystal compounds can be used, with those curable by ultraviolet (UV) irradiation being suitable. The polymerizable liquid crystal compounds are also called reactive mesogens (RMs).

Examples of the polymerizable liquid crystal compounds 31A and 31B include polymers each having a structure with both a mesogen group and a photoreactive group in its side chain and having an acrylate, methacrylate, maleimide, N-phenylmaleimide, siloxane, or another structure in its main chain. The mesogen group may be a biphenyl group, a terphenyl group, a naphthalene group, a phenylbenzoate group, an azobenzene group, or a derivative of any of these groups. The photoreactive group may be a cinnamoyl group, a chalcone group, a cinnamylidene group, a β-(2-phenyl)acryloyl group, a cinnamic acid group, or a derivative of any of these groups.

The polymerizable liquid crystal compounds 31A and 31B may each be a homopolymer defined by a single repeating unit, or a copolymer defined by two or more repeating units with different side chain structures. The term “copolymer” includes all of alternating, random, and graft types.

The chiral agent may be of any type, and conventionally known chiral agents can be used. The chiral agent may be, for example, S-811 (available from Merck KGaA).

The polymerizable liquid crystal compounds 31A and 31B and the chiral agent may be dissolved in a solvent and applied. The solvent may be any solvent that can dissolve the polymerizable liquid crystal compounds 31A and 31B and the chiral agent may be used. Examples thereof include propylene glycol monomethyl ether acetate (PGMEA).

The optical element according to Embodiment 1, including the alignment film 20 with the patterned in-plane alignment regulating force and the cholesteric liquid crystal layer 30 aligned by the alignment film 20, is categorized as an element called polymerization volume hologram (PVH). A PVH used in light guide plate applications is referred to as a coupling element or a coupler. The optical element according to Embodiment 1 is used as a coupling element in applications such as AR glass applications. Also, the optical element according to Embodiment 1 can be used as a diffraction grating, and is preferably a diffraction element with tilted Bragg planes.

### Embodiment 2

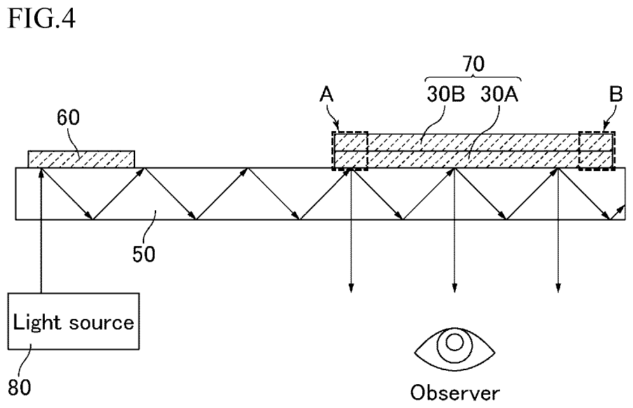

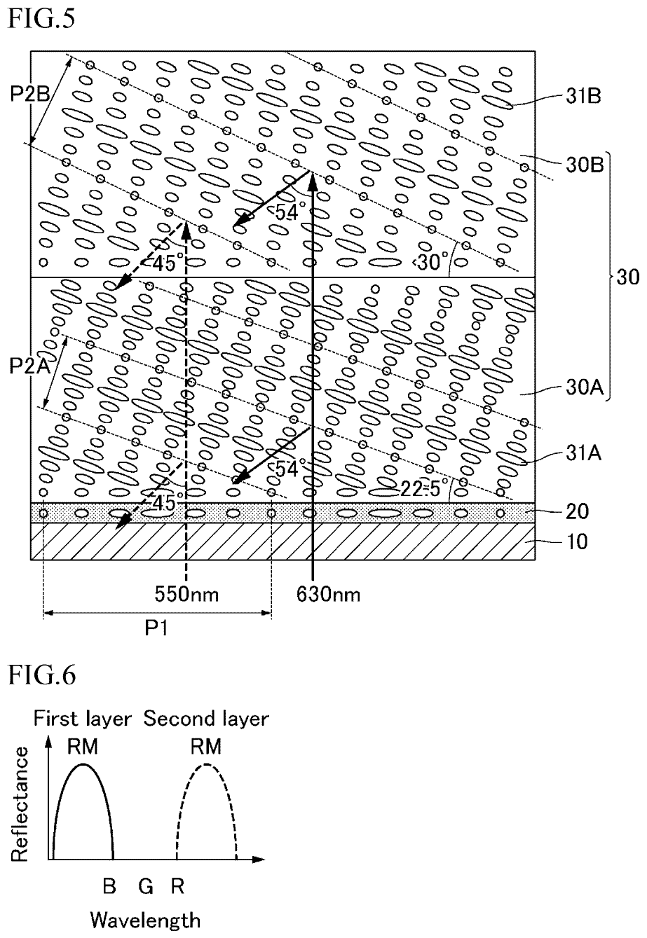

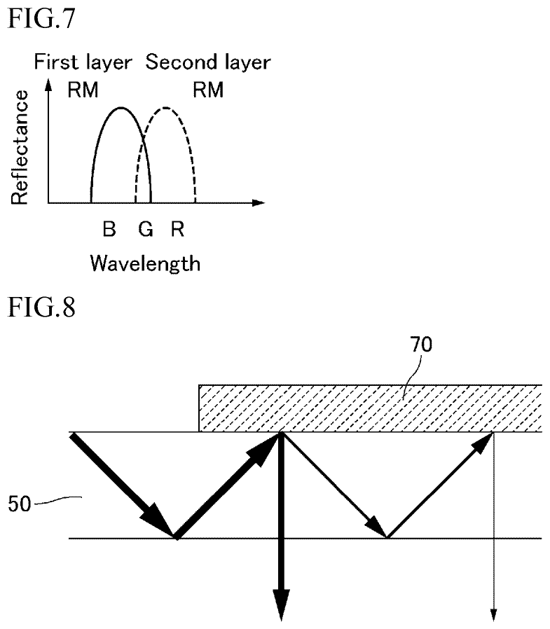

FIG. 4 is a schematic cross-sectional view of a light guide element according to Embodiment 2. FIG. 5 is an enlarged cross-sectional view of a first region A in FIG. 4. FIG. 6 is a graph schematically showing the reflection spectra of cholesteric liquid crystal layers in the first region A in FIG. 4. FIG. 7 is a graph schematically showing the reflection spectra of the cholesteric liquid crystal layers in a second region B in FIG. 4. As shown in FIG. 4, the light guide element according to Embodiment 2 includes a light guide plate 50, a light incident-side optical element (first coupling element) 60 mounted on the light incident side of the light guide plate 50, and a light emission-side optical element (second coupling element) 70 mounted on the light emission side of the light guide plate 50. For example, when the length of the light guide plate 50 in the lateral direction in FIG. 4 is 70 mm, the light incident-side optical element 60 is arranged at a position 10 mm to 15 mm from an end portion (left end in FIG. 4) of the light guide plate 50, and the light emission-side optical element 70 is arranged at a position 40 mm to 60 mm from the end portion (left end in FIG. 4) of the light guide plate 50. The arrows in FIG. 4 indicate the path of light incident on the light guide plate.

The light emission-side optical element (outcoupler) 70 in the present embodiment corresponds to the optical element according to Embodiment 1. In a cholesteric liquid crystal layer 30 included in the outcoupler 70, a first end portion positioned in or adjacent to the first region A corresponds to the end portion closest to the light incident-side end portion of the light guide plate 50, and a second end portion positioned in or adjacent to the second region B corresponds to the end portion farthest from the light incident-side end portion of the light guide plate 50.

The light guide plate 50 can be one conventionally known in the field of liquid crystal display devices. In the light guide element according to Embodiment 2, at least one of the light incident-side optical element 60 or the light emission-side optical element 70 is the optical element according to Embodiment 1. In particular, the light emission-side optical element 70 is preferably the optical element according to Embodiment 1.

The light guide element according to Embodiment 2 is suitable for augmented reality (AR) display devices. When an AR display device incorporates the light guide element according to Embodiment 2, a display module is arranged as a light source 80 at a position facing the light incident-side optical element 60. The display module (the light source 80) may face the light incident-side optical element 60 across the light guide plate 50 as shown in FIG. 4, or may face the light incident-side optical element 60 without the light guide plate 50 (That is, the display module (the light source 80) may be positioned on a side opposite to the light guide plate 50 with respect to the light incident-side optical element 60). The display module may be any display module that displays contents compatible with AR technology. For example, a thin-profile display such as a liquid crystal display module or an organic EL display module can be used.

The AR display device including the light guide element according to Embodiment 2 is preferably AR glasses shaped like eyeglasses. In AR glasses, light from the display module enters the light guide plate 50, and is guided in the direction designed by the light incident-side optical element (incoupler) 60 mounted adjacent to the light incident-side end portion of the light guide plate 50. Thereafter, the light propagates through the inside of the light guide plate 50, from one end (the end where the light incident-side optical element 60 is arranged) to the other end (the end where the light emission-side optical element 70 is arranged), while being repeatedly reflected at the interfaces between the light guide plate 50 and air. The light having reached the light emission-side end portion of the light guide plate 50 is reflected by the light emission-side optical element (outcoupler) 70 to enter the eyes of the observer (user), so that the observer can perceive the images on the display module.

When the light guide element is applied to AR glasses, the outcoupler 70 is preferably larger than the light receiving area of the human eye. The size of the outcoupler 70 in the horizontal direction is 20 mm, for example. When the reflectance of the outcoupler 70 is lower than 100%, light that enters the outcoupler 70 is split into a component that is visible to the observer and a component that continues to propagate through the light guide plate. The continuous propagation allows light to be emitted from the outcoupler 70 at various positions within the plane, from which the light enters the observer's eyes. This allows the observer to see images even when their eyes move. The region where the observer can see the video even when their eyes move is referred to as “eye box”. Preferably, 95% or more of light from the light source is emitted into the eye box, for example, by adjusting the size of the outcoupler 70 in the horizontal direction, reflectance, and other conditions.

Also, when the light guide element is applied to AR glasses, for example, the thickness of the light guide plate 50 is set to 1 mm, and the diffraction angles (for example, diffraction angles for light with a wavelength of 550 nm) of the incoupler 60 and the outcoupler 70 are set to 45°. The diffraction angles of the incoupler 60 and the outcoupler 70 depend on the in-plane pattern period P1, and the diffraction angles (reflection surfaces) differ for each wavelength of light (see FIG. 5). The first cholesteric liquid crystal layer 30A and the second cholesteric liquid crystal layer 30B whose in-plane pattern periods P1 are the same exhibit the same diffraction angle for light with any wavelength. Specifically, the first cholesteric liquid crystal layer 30A and the second cholesteric liquid crystal layer 30B have a diffraction angle of 45° for light with a wavelength of 550 nm and a diffraction angle of 54° for light with a wavelength of 630 nm. In the first cholesteric liquid crystal layer 30A, the Bragg surface tilted at 22.5° serves as the reflective surface for light with a wavelength of 550 nm. The helical pitches P2A and P2B of the first cholesteric liquid crystal layer 30A and the second cholesteric liquid crystal layer 30B define the diffraction efficiencies. In the first region A shown in FIG. 4, the diffraction efficiency of the first cholesteric liquid crystal layer 30A is 10%, and the diffraction efficiency of the second cholesteric liquid crystal layer 30B is 15%.

When entering the main surface of the light guide plate 50 from the normal direction, light with a wavelength of 550 nm is totally reflected at an angle of 45° within the light guide plate 50 by the incoupler 60, and is emitted in the normal direction by the outcoupler 70. With the reflectance of the outcoupler 70 being adjusted to 30%, 90% or more of light from the light source is emitted into the eye box.

In order to improve the display quality of AR glasses, the coupler needs to function properly with RGB light components. However, since the reflection spectrum of a PVH has a certain width, similar to the selective reflection seen in typical cholesteric liquid crystals, a PVH cannot reflect light across the entire RGB wavelength range. The present inventors therefore examined a method of stacking PVHs with different chiral pitches. However, when the first-layer polymerizable liquid crystal compound is fully cured, alignment disturbance in the second-layer polymerizable liquid crystal compound and repellence of the coating liquid occur, meaning that the method involves challenges such as chiral pitch control, an increased number of processes, and increased cost. In response to the challenges, the present inventors arrived at coating a partially cured polymerizable liquid crystal compound serving as a base with a polymerizable liquid crystal compound to enable stacking of PVHs with different chiral pitches, thereby achieving a PVH with a unform reflectance for light across the entire RGB wavelength range.

FIG. 8 is a diagram illustrating occurrence of luminance unevenness when the reflectance of a coupler is uniform within the plane. In order to improve the display quality of AR glasses, the AR glasses preferably allow the observer to see the video on the display module even when their eyes move. When light is applied to a plurality of positions of the coupler, the range within which the observer can see the video on the display module (eye box) can be widened. However, as shown in FIG. 8, when the reflectance of the coupler is uniform within the plane, the intensity of light emitted from the light guide plate 50 is higher at a position closer to the light source, meaning that in-plane luminance unevenness may occur. On the contrary, the outcoupler 70 in the present embodiment has different reflection spectra in the first region A closer to the light incident portion of the light guide plate 50 and in the second region B farther from the light incident portion of the light guide plate 50 to achieve more uniform emission light luminance distribution. Specifically, as shown in FIGS. 6 and 7, in the stack of the first cholesteric liquid crystal layer 30A and the second cholesteric liquid crystal layer 30B, the reflectance in the first region A exhibits a peak within the wavelength range of 450 nm or shorter and a peak within the wavelength range of 650 nm or longer, and the reflectance in the second region B exhibits two peaks within the wavelength range of 450 nm or longer and 650 nm or shorter.

The stack of the first cholesteric liquid crystal layer 30A and the second cholesteric liquid crystal layer 30B, having the following configuration (1) or (2), can achieve a uniform luminance distribution of emission light.
(1) The first cholesteric liquid crystal layer 30A has a shorter helical pitch P2A in the first region A closer to the light incident portion of the light guide plate 50 than in the second region B farther from the light incident portion of the light guide plate 50, and the second cholesteric liquid crystal layer 30B has a longer helical pitch P2B in the first region A than in the second region B. In the region between the first region A and the second region B, the helical pitch P2A in the first cholesteric liquid crystal layer 30A may gradually increase in the direction from the first region A toward the second region B and the helical pitch P2B in the second cholesteric liquid crystal layer 30B may gradually decrease in the direction from the first region A toward the second region B.
(2) The first cholesteric liquid crystal layer 30A has a longer helical pitch P2A in the first region A closer to the light incident portion of the light guide plate 50 than in the second region B farther from the light incident side of the light guide plate 50, and the second cholesteric liquid crystal layer 30B has a shorter helical pitch P2B in the first region A than in the second region B. In the region between the first region A and the second region B, the helical pitch P2A in the first cholesteric liquid crystal layer 30A may gradually decrease in the direction from the first region A toward the second region B and the helical pitch P2B in the second cholesteric liquid crystal layer 30B may gradually increase in the direction from the first region A toward the second region B.

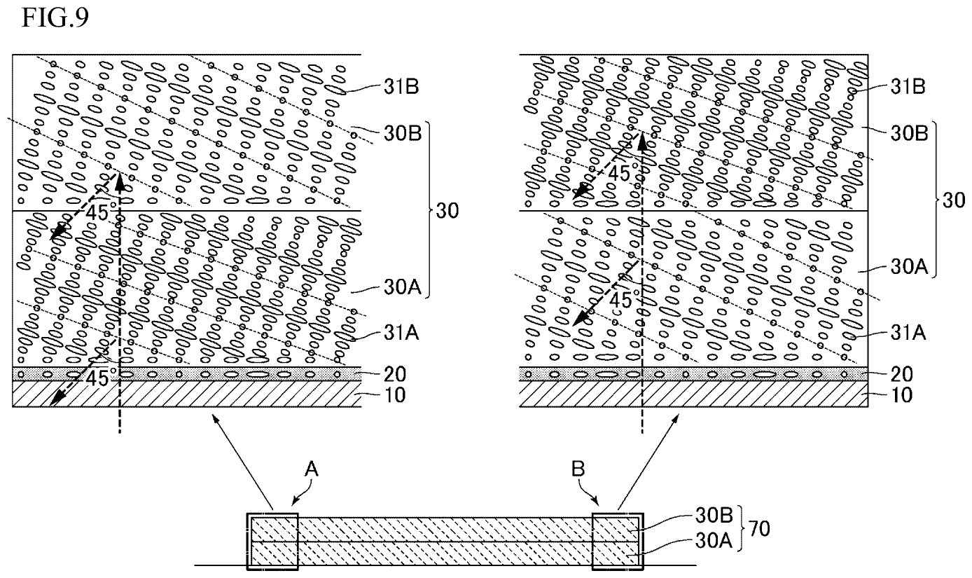

FIG. 9 is a cross-sectional view used to illustrate the diffraction angles of an optical element according to Embodiment 2. As shown in FIG. 9, in the stack of the first cholesteric liquid crystal layer 30A and the second cholesteric liquid crystal layer 30B, the diffraction angle for light with a wavelength of 550 nm is constant at 45° between the first region A and the second region B. In the stack of the first cholesteric liquid crystal layer 30A and the second cholesteric liquid crystal layer 30B, the diffraction efficiency (tilt angle on the Bragg surface) varies from the first region A toward the second region B, with the diffraction efficiency being adjusted to be higher in the second region B than in the first region A.

When the optical element (coupler) according to Embodiment 2 is used in AR glasses, the luminance in the eye box can be made uniform within the visible spectrum from 400 to 700 nm.

### Embodiment 3

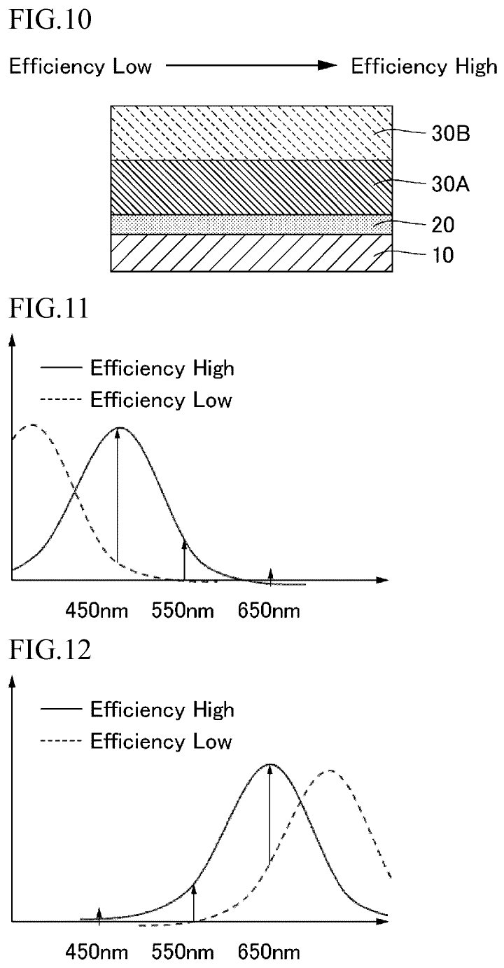

Embodiment 3 describes another example in which the reflectance spectra of the first cholesteric liquid crystal layer 30A and the second cholesteric liquid crystal layer 30B are different from those shown in FIGS. 6 and 7. FIG. 10 is a cross-sectional view schematically showing the configuration of an optical element according to Embodiment 3. FIG. 11 is a graph showing the reflection spectrum of a first PVH in FIG. 10. FIG. 12 is a graph showing the reflection spectrum of a second PVH in FIG. 10.

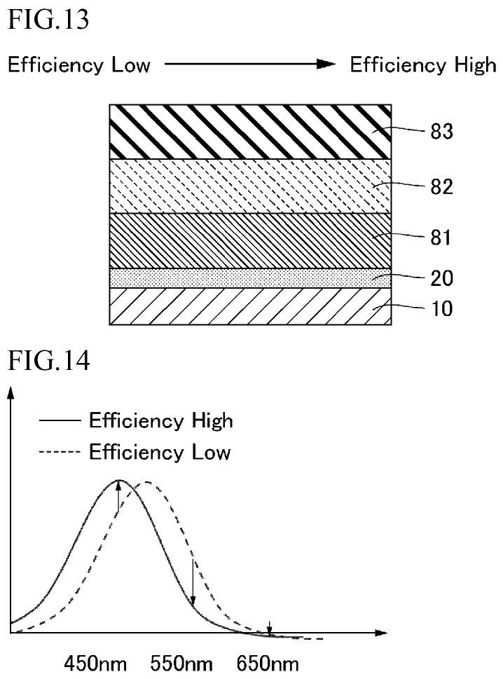

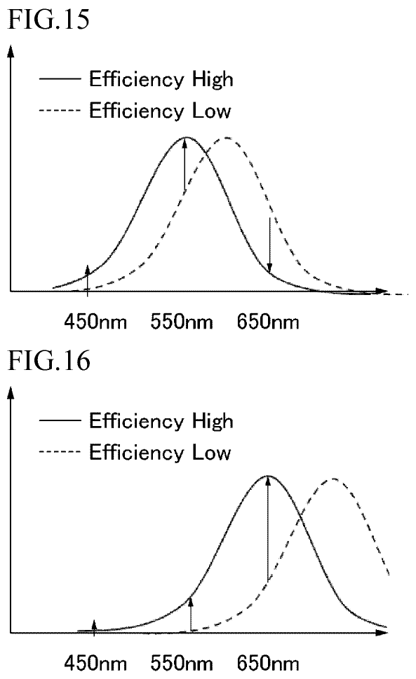

To increase the diffraction efficiency of an optically anisotropic layer in an optical element from one side toward the other side along the light propagation direction, the double-layer structure PVH consisting of the first cholesteric liquid crystal layer 30A and the second cholesteric liquid crystal layer 30B is more suitable than a triple-layer structure PVH in terms of achieving better luminance uniformity. FIG. 13 is a cross-sectional view schematically showing a triple-layer structure PVH. FIG. 14 is a graph showing the reflection spectrum of a first PVH in FIG. 13. FIG. 15 is a graph showing the reflection spectrum of a second PVH in FIG. 13. FIG. 16 is a graph showing the reflection spectrum of a third PVH in FIG. 13.

The triple-layer structure PVH shown in FIG. 13 has a configuration in which an alignment film 20, a first PVH 81, a second PVH 82, and a third PVH 83 are stacked on a support 10, and exhibits a diffraction efficiency that increases from the light incident-side end portion toward the other end portion. The first PVH 81 is adjusted to reflect blue (B) light. The second PVH 82 is adjusted to reflect green (G) light. The third PVH 83 is adjusted to reflect red (R) light. In the other end portion where the diffraction efficiency is set higher, the third PVH 83 exhibits a higher diffraction efficiency than in the light incident-side end portion across the entire RGB wavelength range, while the first PVH 81 exhibits a higher diffraction efficiency than in the light incident-side end portion in the B wavelength range but exhibits a lower diffraction efficiency than in the light incident-side end portion in the R and G wavelength ranges. Also, the second PVH 82 exhibits a higher diffraction efficiency than in the light incident-side end portion in the G and B wavelength ranges but exhibits a lower diffraction efficiency than in the light incident-side end portion in the R wavelength range. When such PVHs for RGB light components are stacked, shifting the selective reflection wavelength of the PVH for the G light component causes a decrease in G diffraction efficiency but an increase in B or R diffraction efficiency, possibly failing to obtain an ideal diffraction efficiency in-plane distribution. For example, in a low diffraction efficiency region, the G diffraction efficiency may be sufficiently low but the R diffraction efficiency may be somewhat high. As a result, uniform luminance within the eye box may not be achieved across the entire visible light spectrum.

The optical element according to Embodiment 3 including the double-layer structure PVH shown in FIG. 10 has a configuration in which the alignment film 20, the first cholesteric liquid crystal layer (first PVH) 30A, and the second cholesteric liquid crystal layer (second PVH) 30B are stacked on the support 10, and exhibits a diffraction efficiency that increases in the direction from the light incident-side end portion toward the other end portion. Both the first cholesteric liquid crystal layer (first PVH) 30A and the second cholesteric liquid crystal layer (second PVH) 30B exhibit a higher reflection efficiency in the other end portion where the diffraction efficiency is set higher than in the light incident-side end portion across the entire RGB wavelength range. In terms of such simultaneous decrease (or increase) in diffraction efficiency of the double PVH layers for RGB light components, the optical element according to Embodiment 3 including the double-layer structure PVH is excellent.

### EXAMPLES

### Examples and Comparative Examples

Hereinbelow, examples and comparative examples are described, but the present invention is not limited to these examples.

### Comparative Example 1

In Comparative Example 1, the selective reflection wavelength of a sample with a single-layer film of a polymerizable liquid crystal compound containing a chiral agent was evaluated. The sample was produced by the following procedure.
(1) A photoisomerization-type photoalignment film was formed on a glass substrate.
(2) The photoalignment film was irradiated with polarized ultraviolet (UV) light with a wavelength of 365 nm at 100 mJ/cm². Then, the photoalignment film was baked for 20 minutes in an oven at 160° C.
(3) The photoalignment film was coated with a polymerizable liquid crystal compound containing a chiral agent using a spin coater rotating at 1000 rpm. The concentration of the chiral agent was adjusted such that the selective reflection wavelength would be 650 nm. The polymerizable liquid crystal compound exhibited positive wavelength dispersion, with the following relationships observed: Re (450 nm)/Re (550 nm) ≈1.14; and Re (650 nm)/Re (550 nm)≈0.94.
(4) The applied polymerizable liquid crystal compound was irradiated with non-polarized UV light with a wavelength of 365 nm at 3 J/cm² to cure the polymerizable liquid crystal compound, whereby the sample was completed.

The completed sample had a configuration in which a photoalignment film and a cholesteric liquid crystal layer were stacked on a glass substrate. The cholesteric liquid crystal layer contained a polymer of a polymerizable liquid crystal compound and a chiral agent.

### Evaluation

The thickness of the cholesteric liquid crystal layer was measured using non-contact 3D measuring instrument “NH-3MA” available from Mitaka Kohki Co., Ltd. The measurement indicated that the thickness of the cholesteric liquid crystal layer was 1.5 μm.

The transmittance values Tmax and Tmin of the cholesteric liquid crystal layer were measured using “Axoscan” available from Axometrics, Inc. The reflectance R of the cholesteric liquid crystal layer was calculated from the following formula.

$$R ( \% ) = ( 1 - Tmin / Tmax ) \times 100$$

Tmax refers to the transmittance obtained when the polarization state of the incident light is set to yield the highest transmittance. Tmin refers to the transmittance obtained when the polarization state of the incident light is set to yield the lowest transmittance. The cholesteric liquid crystal layer exhibited the highest transmittance for incident right-handed circularly polarized light and the lowest transmittance for incident left-handed circularly polarized light.

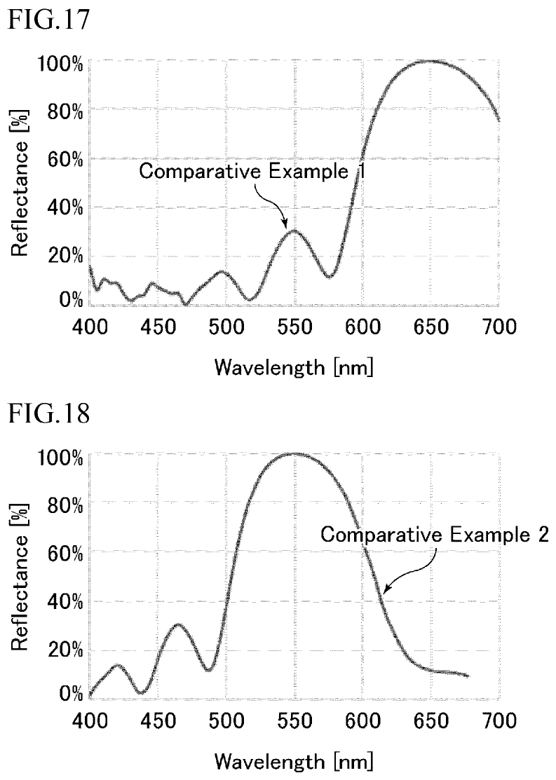

FIG. 17 is a graph showing the reflectance of a cholesteric liquid crystal layer in Comparative Example 1. In FIG. 17, the maximum reflectance was normalized to 100%, and the selective reflection wavelength was observed at 650 nm. The maximum reflectance (reflectance at the wavelength of 650 nm) before normalization was 82%.

### Comparative Example 2

In Comparative Example 2, the selective reflection wavelength of a single-layer film of a polymerizable liquid crystal compound containing a chiral agent was evaluated using the same procedure as in Comparative Example 1, except that the concentration of the chiral agent was adjusted such that the selective reflection wavelength would be 550 nm.

FIG. 18 is a graph showing the reflectance of a cholesteric liquid crystal layer in Comparative Example 2. In FIG. 18, the maximum reflectance was normalized to 100%, and the selective reflection wavelength was observed at 550 nm.

### Example 1

In Example 1, the selective reflection wavelength of a sample with a single-layer film of a polymerizable liquid crystal compound containing a chiral agent, coated with the same polymerizable liquid crystal compound containing a chiral agent, was evaluated. The sample was produced by the following procedure.
(1) A photoisomerization-type photoalignment film was formed on a glass substrate.
(2) The photoalignment film was irradiated with polarized ultraviolet (UV) light with a wavelength of 365 nm at 100 mJ/cm². Then, the photoalignment film was baked for 20 minutes in an oven at 160° C.
(3) The photoalignment film was coated with a first polymerizable liquid crystal compound containing a chiral agent using a spin coater rotating at 1000 rpm. The concentration of the chiral agent was adjusted such that the selective reflection wavelength would be 550 nm as in Comparative Example 2. The first polymerizable liquid crystal compound exhibited positive wavelength dispersion, with the following relationships observed: Re (450 nm)/Re (550 nm) ≈1.14; and Re (650 nm)/Re (550 nm)≈0.94.
(4) The applied first polymerizable liquid crystal compound was irradiated with non-polarized UV light with a wavelength of 365 nm at 1 J/cm² to cure the polymerizable liquid crystal compound. The irradiation energy of the non-polarized UV light in Example 1 was smaller than that in Comparative Example 1, and the first polymerizable liquid crystal compound was not fully cured at this time point. This state of curing is defined as a “partially cured” state.
(5) The partially cured first polymerizable liquid crystal compound was coated with a second polymerizable liquid crystal compound containing a chiral agent using a spin coater rotating at 1000 rpm. The second polymerizable liquid crystal compound had the same composition and was used in the same amount as the first polymerizable liquid crystal compound.
(6) The stack of the first and second polymerizable liquid crystal compounds was irradiated with non-polarized UV light with a wavelength of 365 nm at 3 J/cm² to cure the first and second polymerizable liquid crystal compounds, whereby the sample was completed.

The completed sample had a configuration in which a photoalignment film, a first cholesteric liquid crystal layer, and a second cholesteric liquid crystal layer were sequentially stacked on a glass substrate. The first and second cholesteric liquid crystal layers contained a polymer of a polymerizable liquid crystal compound and a chiral agent.

### Evaluation

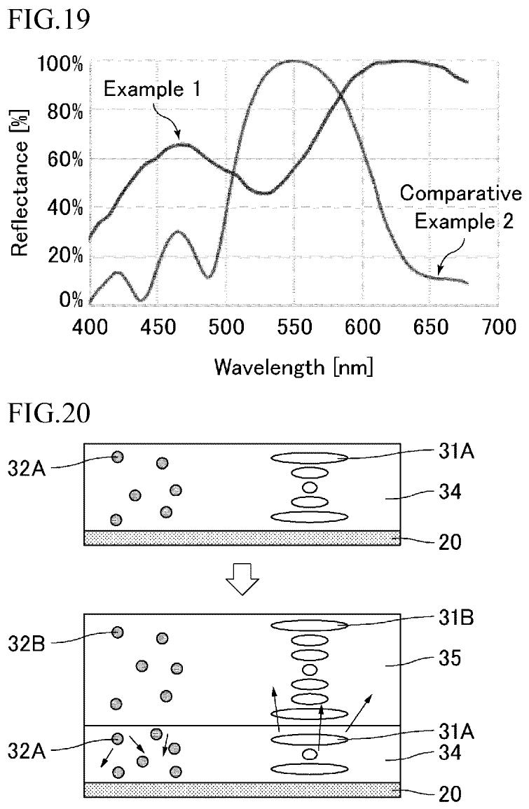

The transmittance values Tmax and Tmin of the cholesteric liquid crystal layer were measured using “Axoscan” available from Axometrics, Inc. The reflectance R of the cholesteric liquid crystal layer was calculated. The reflectance R of the cholesteric liquid crystal layer in Example 1 corresponds to the combined reflectance values of the first and second cholesteric liquid crystal layers. FIG. 19 is a graph showing the reflectance of cholesteric liquid crystal layers in Example 1 and Comparative Example 2. As shown in the figure, the maximum reflectance values in Comparative Example 2 and Example 1 were normalized to 100%. In Comparative Example 2, the selective reflection wavelength (peak wavelength) of the cholesteric liquid crystal layer was observed at 550 nm, whereas in Example 1, the selective reflection wavelength of the cholesteric liquid crystal layer was split, with peaks observed at 620 nm and 470 nm.

The mechanism of the splitting of the selective reflection wavelength is described below. FIG. 20 is a flow diagram illustrating the mechanism by which the selective reflection wavelength of a cholesteric liquid crystal layer is split.

In the polymerizable liquid crystal compound 31A, the concentration of a chiral agent 32A was adjusted such that the polymerizable liquid crystal compound 31A upon curing by a typical method would be formed into a first cholesteric liquid crystal layer which reflects green light. When the polymerizable liquid crystal compound 31A is irradiated with UV into a partially cured state, the concentration of the chiral agent 32A does not change. Thus, a partially cured film 34 obtained by partially curing the polymerizable liquid crystal compound 31A reflects green light. When a coating film 35 containing the polymerizable liquid crystal compound 31B is formed on the partially cured film 34, the chiral agent 32A in the partially cured film 34 diffuses in the substrate direction and the polymerizable liquid crystal compound 31A diffuses toward the coating film 35, leading to an increase in the chiral agent concentration in the partially cured film 34 and a decrease in the chiral agent concentration in the coating film 35. This shifts the selective reflection wavelength of the first cholesteric liquid crystal layer 30A obtained by curing the partially cured film 34 toward shorter wavelengths, resulting in blue reflection, while shifting the selective reflection wavelength of the second cholesteric liquid crystal layer 30B obtained by curing the coating film 35 toward longer wavelengths, resulting in red reflection. As a result, split peaks are observed in the selective reflection wavelength as in the present example. In order to diffuse the polymerizable liquid crystal compound 31A toward the coating film 35, the polymerizable liquid crystal compound 31B preferably contains the same type of solvent as the polymerizable liquid crystal compound 31A.

According to the mechanism, the degree of splitting of the selective reflection wavelength depends on the degree of curing of the first cholesteric liquid crystal layer at the time of application of the second polymerizable liquid crystal compound. In the following Example 2, the UV irradiation energy for the first layer is changed to confirm the changes in reflectance at RGB wavelengths. In the following Example 3, the degree of splitting of the selective reflection wavelength is varied in the plane to confirm that the reflectance at RGB wavelengths can be individually distributed within the plane. To improve the display quality of AR glasses, it is preferred to form regions exhibiting high and low diffraction efficiencies for RGB light components within the plane of the light guide plate. For example, a double-layer cholesteric liquid crystal layer with peaks of the selective reflection wavelength in blue and red wavelength ranges exhibits a high diffraction efficiency for RGB light components, while a double-layer cholesteric liquid crystal layer with peaks in ultraviolet and infrared wavelength ranges exhibits a low diffraction efficiency for RGB light components. Thus, adjusting the degree of splitting of the selective reflection wavelength enables formation of a region exhibiting high diffraction efficiency for RGB light components and a region exhibiting low diffraction efficiency for RGB light components within the plane of the light guide plate.

### Example 2

In Example 2, a sample was produced using the same procedure as in Example 1, except that the irradiation energy of non-polarized UV light for the applied first polymerizable liquid crystal compound was adjusted to 2 J/cm² or 2.5 J/cm². The first cholesteric liquid crystal layer was partially cured upon irradiation with non-polarized UV light both at 2 J/cm² and at 2.5 J/cm², but was closer to the fully cured state upon irradiation at 2.5 J/cm². The reflectance R of the cholesteric liquid crystal layer in the sample of Example 2 was calculated as in Example 1.

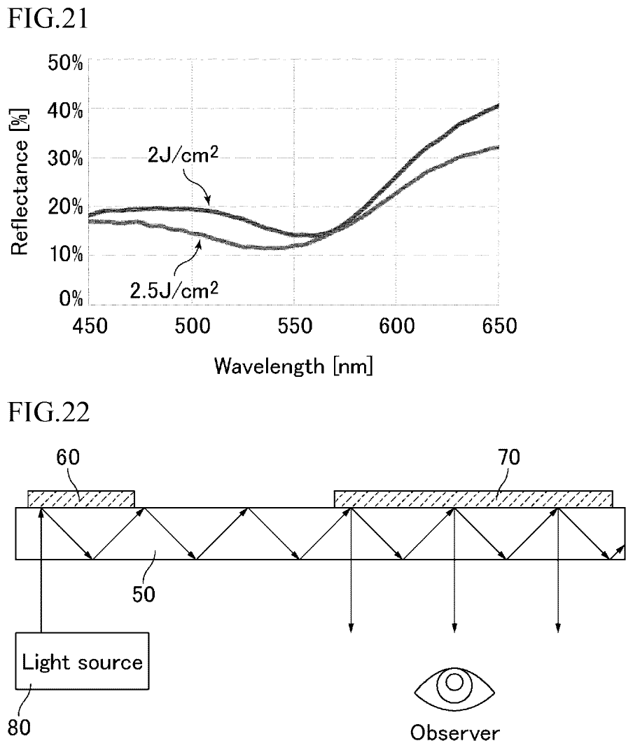

FIG. 21 is a graph showing the reflectance of a cholesteric liquid crystal layer in Example 2. The reflectance shown in FIG. 21 was not normalized and represents absolute values. As shown in the figure, the reflection spectra of the cholesteric liquid crystal layer differed between the cases of 2 J/cm² and 2.5 J/cm², with the case of UV curing at 2.5 J/cm² showing overall lower reflectance. Also, the selective reflection wavelength exhibited different peaks in the 2 J/cm² case and the 2.5 J/cm² case. As is clear at shorter wavelengths, the peak in the 2.5 J/cm² case was farther from 550 nm than the peak in the 2 J/cm² case.

The graph indicates that varying the UV irradiance enables a decrease or increase in reflectance for all the RGB light components. With this characteristic, the in-plane luminance uniformity can be enhanced (see Example 3).

### Comparative Example 3

In Comparative Example 3, based on an assumption of a light guide element for one-dimensional AR devices, the in-plane luminance distribution was evaluated for the case where the coupler had uniform reflectance.

FIG. 22 is a schematic cross-sectional view of a light guide element for AR devices. The light guide element for AR devices consists of a light source, a light guide plate, an incoupler, and an outcoupler. Light emitted from the light source is redirected by the incoupler to propagate within the light guide plate. When the light that has been repeatedly guided within the light guide plate hits the outcoupler, part of the light is redirected to exit from the light guide plate. This allows the observer to see the video due to the light provided by the light source.

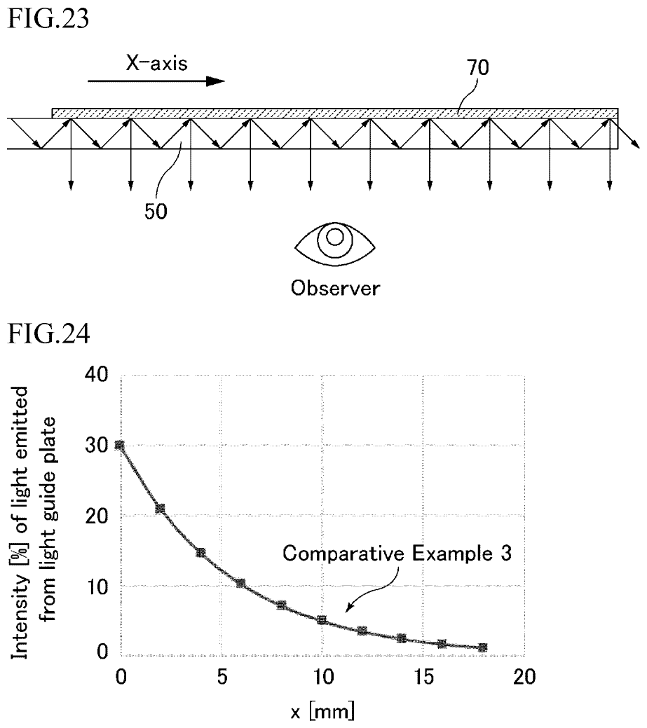

FIG. 23 is a schematic diagram of the light-guiding behavior of an outcoupler in a light guide element of Comparative Example 3. The proportion of the light components exiting the light guide plate 50 among the light components incident on the outcoupler 70 is referred to as the “reflectance of the outcoupler”. The outcoupler 70 is larger than the light receiving area of the human eye as shown in FIG. 23. The reflectance of the outcoupler 70 is lower than 100%, and the light incident on the outcoupler 70 is split into a component that is visible to the observer and a component that continues to propagate through the light guide plate. The continuous propagation allows light components to be emitted from the outcoupler 70 at various positions within the plane, from which the light enters the observer's eyes. This is a technique to allow the observer to see images even when their eyes move. The region where the observer can see the video even when their eyes move is referred to as “eye box”.

In the present comparative example, the light intensity distribution within the eye box when the reflectance of the outcoupler 70 was uniform within the plane was calculated. The thickness of the light guide plate 50 was 1 mm, and the diffraction angles of the incoupler 60 and the outcoupler 70 for light with a wavelength of 550 nm were 45°. In this case, light incident on the light guide plate 50 from the normal direction is totally reflected at an angle of 45° within the light guide plate, and is emitted in the normal direction by the outcoupler 70. The size of the outcoupler 70 was 20 mm, and the reflectance of the outcoupler 70 was 30% such that 95% or more of light from the light source was emitted into the eye box. In this case, the incident light is reflected by the outcoupler 70 ten times, and 97% of the incident light reaches the observer.

### Evaluation of In-Plane Uniformity

The intensity of light incident on the outcoupler 70 was defined as 100%. When the reflectance of the outcoupler 70 is denoted as T, the intensity of the light emitted from the light guide plate is expressed by 100%×T, and the intensity of light that continues to propagate through the light guide plate is expressed by 100%×(1−T). Therefore, the intensity of light emitted from the light guide plate 50 after the n-th reflection is represented by the following calculation formula.

$$Intensity of light emitted from light guide plate at the n - th reflection = 100 \% \times {( 1 - T )}^{( n - 1 )} \times T$$

The x-coordinate of the light guide plate 50 was defined as shown in FIG. 23, and the point at which the light first enters the outcoupler 70 was denoted as x=0. FIG. 24 is a graph showing the relationship between the x-coordinate and the intensity of light emitted from the light guide plate in Comparative Example 3. As shown in the figure, naturally, the light intensity was higher at a position closer to the light source. This means that the luminance of the displayed video changes as the observer moves their eyes, which indicates poor display quality. In contrast, in Example 3 described below, the in-plane luminance uniformity is improved by varying the reflectance of the outcoupler 70 in the x direction.

### Example 3

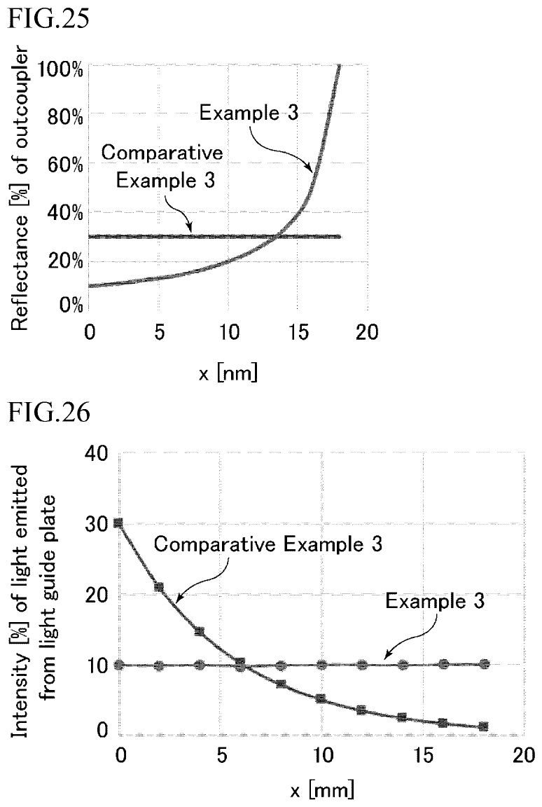

In Example 3, the in-plane luminance distribution of the light guide element for one-dimensional AR devices was evaluated as in Comparative Example 3, except that the reflectance of the coupler was varied in the x direction. FIG. 25 is a graph showing the x-direction dependence of the reflectance of the outcouplers in Comparative Example 3 and Example 3. As shown in the graph, the outcoupler of Example 3 exhibited a higher reflectance as the x-coordinate increased.

### Evaluation of In-Plane Uniformity

FIG. 26 is a graph showing the calculation results of the relationship between the x-coordinate and the intensity of emitted light (in-plane luminance distribution) when the outcouplers in Comparative Example 3 and Example 3 are used. The in-plane luminance distribution can be calculated using the above calculation formula in combination with the x-direction dependence of the reflectance of the outcoupler shown in FIG. 25.

The results in the graph clearly show that the in-plane light intensity uniformity is improved by the outcoupler in Example 3. This indicates that varying the reflectance of the coupler within the plane enables enhancement of the display quality.

When a PVH is used as the outcoupler, the thickness of the PVH needs to be varied for in-plane distribution of reflectance, which, however, involves a mass producibility issue. In contrast, the present disclosure enables in-plane distribution of reflectance simply by partially curing the first cholesteric liquid crystal layer and coating the first cholesteric liquid crystal layer with the second cholesteric liquid crystal layer. The in-plane distribution of reflectance may be achieved by increasing the splitting width of the selective reflection wavelength of the cholesteric liquid crystal layer near the light source and decreasing the splitting width as the distance from the light source increases, using a method such as adjusting the transmittance of a photomask used to partially cure the first cholesteric liquid crystal layer.

What is claimed is:

1. An optical element, comprising:
a cholesteric liquid crystal layer including a first cholesteric liquid crystal layer and a second cholesteric liquid crystal layer stacked on the first cholesteric liquid crystal layer,
the first cholesteric liquid crystal layer and the second cholesteric liquid crystal layer each containing a polymer of a polymerizable liquid crystal compound and a chiral agent,
the cholesteric liquid crystal layer including a first region which is closer to a first end portion than to a central portion in a first direction within a plane, and a second region which is closer to a second end portion than to the central portion in the first direction,
the cholesteric liquid crystal layer satisfying one of the following conditions: the first cholesteric liquid crystal layer having a shorter helical pitch in the first region than in the second region and the second cholesteric liquid crystal layer having a longer helical pitch in the first region than in the second region; or
the first cholesteric liquid crystal layer having a longer helical pitch in the first region than in the second region and the second cholesteric liquid crystal layer having a shorter helical pitch in the first region than in the second region.

2. The optical element according to claim 1,
wherein in a region between the first region and the second region of the cholesteric liquid crystal layer,
the helical pitch in the first cholesteric liquid crystal layer gradually increases in a direction from the first region toward the second region and the helical pitch in the second cholesteric liquid crystal layer gradually decreases in the direction from the first region toward the second region, or
the helical pitch in the first cholesteric liquid crystal layer gradually decreases in the direction from the first region toward the second region and the helical pitch in the second cholesteric liquid crystal layer gradually increases in the direction from the first region toward the second region.

3. The optical element according to claim 1,
wherein in the cholesteric liquid crystal layer, a difference between two reflectance peak wavelengths which is the difference between a reflectance peak wavelength in the first cholesteric liquid crystal layer and a reflectance peak wavelength in the second cholesteric liquid crystal layer is smaller in the second region than in the first region.

4. The optical element according to claim 3,
wherein in a region between the first region and the second region of the cholesteric liquid crystal layer, the difference between two reflectance peak wavelengths gradually decreases in the direction from the first region toward the second region.

5. The optical element according to claim 1,
wherein in the cholesteric liquid crystal layer, reflectance in the first region exhibits a peak within a wavelength range of 450 nm or shorter and a peak within a wavelength range of 650 nm or longer, and reflectance in the second region exhibits two peaks within a wavelength range of 450 nm or longer and 650 nm or shorter.

6. The optical element according to claim 1,
wherein the first region includes the first end portion of the cholesteric liquid crystal layer, and
the second region includes the second end portion of the cholesteric liquid crystal layer.

7. A light guide element comprising:
a light guide plate;
a light incident-side optical element mounted on a light incident side of the light guide plate; and
a light emission-side optical element which is the optical element according to claim 1 and is mounted on a light emission side of the light guide plate,
the first end portion of the cholesteric liquid crystal layer is an end portion closest to a light incident-side end portion of the light guide plate, and
the second end portion of the cholesteric liquid crystal layer is an end portion farthest from the light incident-side end portion of the light guide plate.

8. An AR display device, comprising:
the light guide element according to claim 7; and
a display module facing the light incident-side optical element.
